(19) United States
(12) Patent Application Publication
(10) Pub. No.: US 2026/0180699 A1
(43) Pub. Date: Jun. 25, 2026

(54) METHODS AND APPARATUS FOR CROSS-LINK INTERFERENCE REPORTING

(71) Applicant: InterDigital Patent Holdings, Inc., Wilmington, DE (US)

(72) Inventors: Jonghyun PARK, Syosset, NY (US); Moon IL Lee, Melville, NY (US); Paul MARINIER, Brossard (CA); Nazli KHAN BEIGI, Longueuil (CA); Aata EL HAMSS, Laval (CA); Virgile GARCIA, Antibes (FR)

(73) Assignee: InterDigital Patent Holdings, Inc., Wilmington, DE (US)

(21) Appl. No.: 18/990,616

(22) Filed: Dec. 20, 2024

(51) Int. Cl. H04B 17/309; H04B 17/318; H04L 5/00; H04W 76/20

(52) U.S. Cl. CPC H04B 17/346; H04B 17/328; H04L 5/0051; H04W 76/20

(57) ABSTRACT

A wireless transmit and receive unit (WTRU) may perform measurements on reference signals (RSs) received from other WTRUs in order to estimate cross-link interference (CLI) in a full-duplex system. The WTRU may receive, from a network, an indication of one or more reference signals (RSs) to be used by the WTRU to perform the measurements. The WTRU may have the capability to identify and measure the RSs autonomously. The WTRU may also receive an indication of one or more TCI-states to be used when performing CLI measurements. The WTRU may use the current downlink TCI-state to perform the measurement. The TCI-state may be specific to each RS. The RS may be a sounding reference signal (SRS). The CLI may be measured using reference signal received power (RSRP). The WTRU may continuously monitor SRSs and send CLI reports to the network upon detection of an event associated with the measurement.

### BACKGROUND

New Radio (NR) duplex operation may be a great foundation in improving conventional time division duplexing (TDD) operation by enhancing UL coverage, improving capacity, and reducing latency. The conventional TDD system is based on splitting the time domain between uplink and downlink. The feasibility of allowing full-duplex, or more specifically, full-duplex operation at the base station (e.g., gNB), within a conventional TDD band, may be a promising approach.

### SUMMARY

In a full-duplex system comprises slots that may be configured for uplink (UL), for downlink (DL), or for both UL and DL. The full-duplex slot supporting both UL and DL operates by configuring a first group of frequency resources within the bandwidth are allocated to transmission in one direction and a second group of frequency resources within the bandwidth are allocated to transmissions in the other direction.

A full-duplex operation may be non-overlapping, partially overlapping, or fully overlapping. In the case of fully overlapping, a timeslot may be used for both uplink and downlink, using the same component carrier or band. In the case of non-overlapping, a slot may be configured for UL and DL at the same time, but the UL and DL transmissions occur in different sub-bands.

The realization of a full-duplex system is subject to resolving the key challenges raised due to cross-link interference (CLI). In an full-duplex framework, a potential aggressor cell may switch from UL to DL or vice-versa, causing CLI on potential victim base stations (e.g., gNBs) and wireless transmit and receive units (WTRUs). In uplink (UL) to downlink (DL) CLI, the UL transmission from aggressor WTRUs may cause directional CLI at the victim WTRU. The CLI may be measured at both the victim and/or aggressor WTRUs.

A WTRU may determine the CLI via measuring pilot signals or reference signals from other WTRUs. An example of a pilot or reference signal is a sounding reference signal (SRS). When a first WTRU transmits an SRS, a second WTRU may measure the SRS signal strength received. This measurement may indicate the level of interference that the first WTRU may generate in the second WTRU reception. As an example, the second WTRU may measure the SRS reference signal received power (RSRP); a high value of RSRP measured may indicate that the second WTRU may generate high interference level when the first WTRU is receiving DL data from the base station (e.g., gNB).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates a sub-band non-overlapping full-duplex (SBFD) system;

FIG. 3 illustrates cross-link interference (CLI) during full-duplex operation;

FIG. 4 shows an example of a DCI for unified TCI state indications;

FIG. 5 illustrates an example of TCI or beam control across FD and non-FD symbols in a single TRP scenario and under unified TCI (UTCI) framework;

FIG. 6 illustrates an example of reporting CLI measurements for more than one SRS;

FIG. 7 illustrates an example of CLI measurement reporting using mode A;

FIG. 8 illustrates an example of CLI measurement reporting using mode B; and

FIG. 9 illustrates an example of a CLI measurement and reporting procedure.

### DETAILED DESCRIPTION

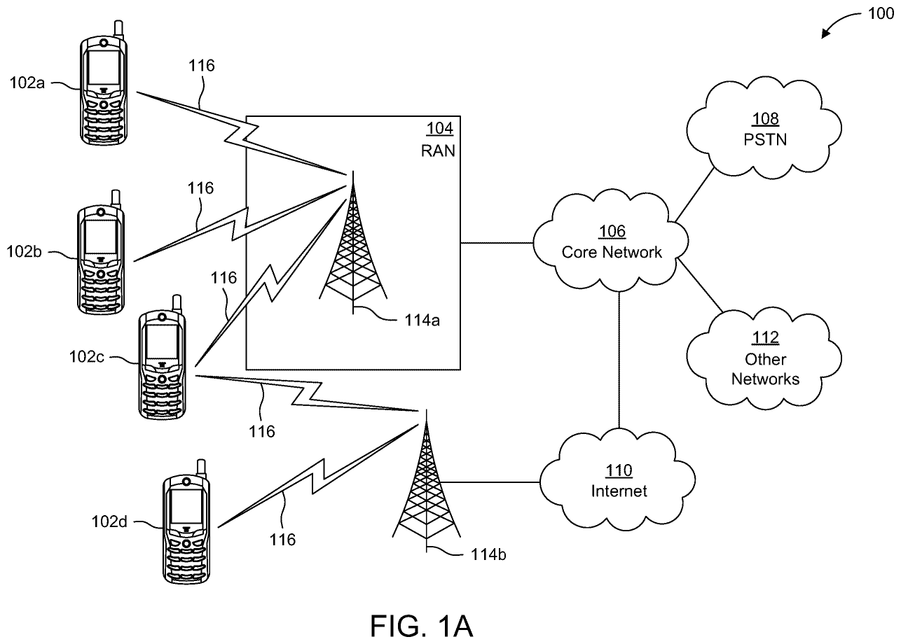

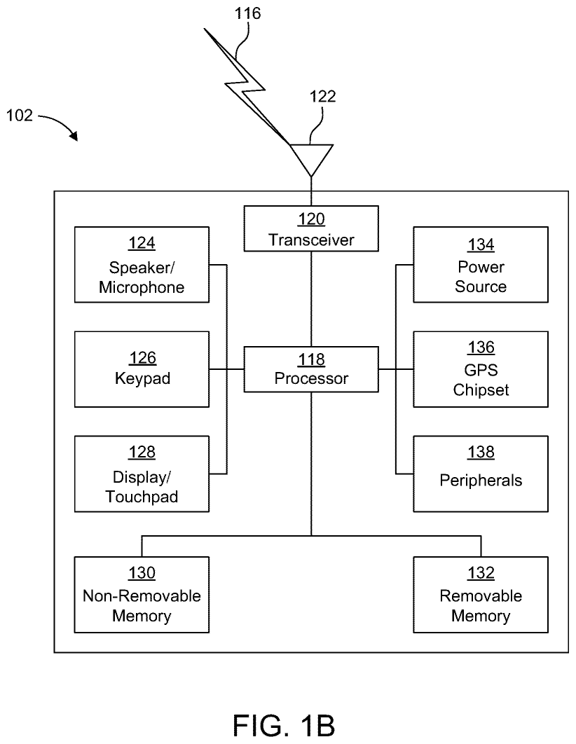

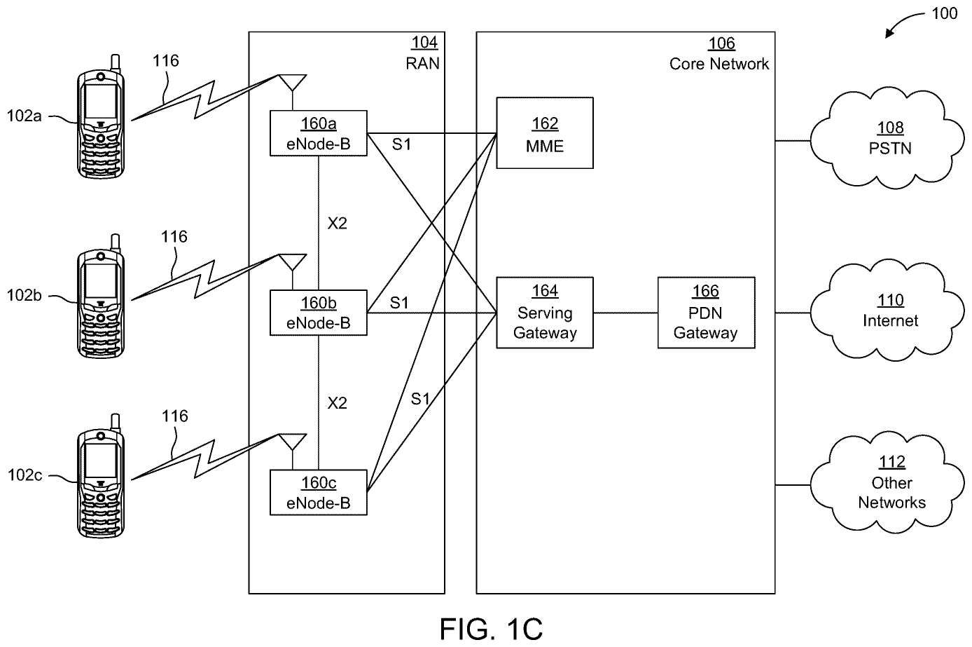

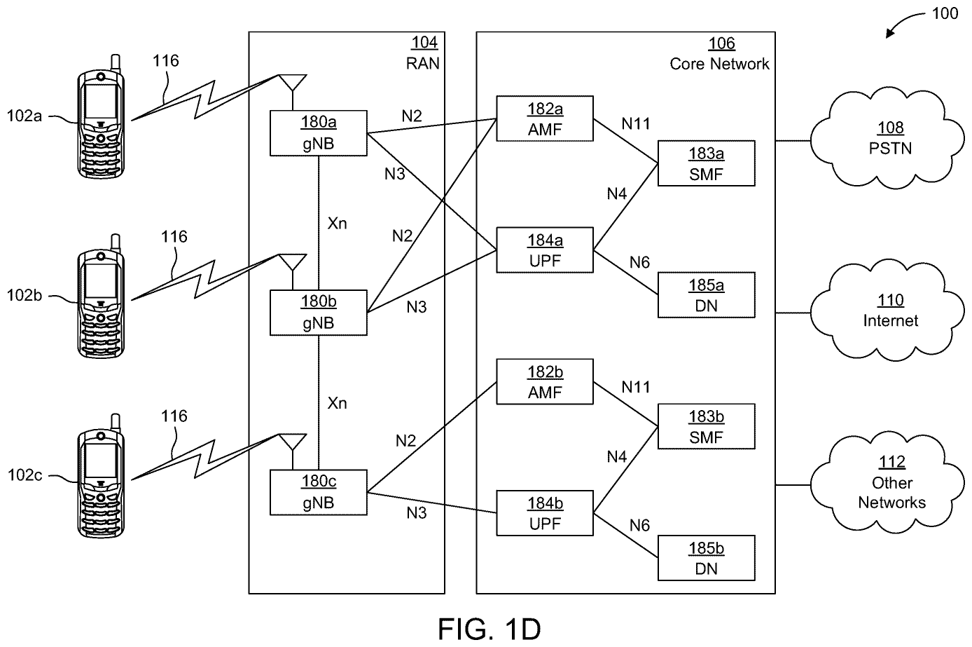

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full-duplex radio for which transmission and reception of some or all of the signals (e.g., associated with particular subframes for both the UL (e.g., for transmission) and DL (e.g., for reception) may be concurrent and/or simultaneous. The full-duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Terminology used in this specification is as follows:

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

The terms pilot signal and reference signals may be used interchangeably. A pilot signal or a reference signal may represent one or more of following: a sounding reference signal (SRS), a channel state information reference signal (CSI-RS); a demodulation reference signal (DM-RS); a phase tracking reference signal (PT-RS); or a synchronization signal block (SSB). The term pilot signal or reference signal (RS) may represent an RS resource, an RS resource set, an RS port, or an RS port group.

A channel may represent one or more of following: physical downlink control channel (PDCCH); physical downlink shared channel (PDSCH); physical uplink control channel (PUCCH); physical uplink shared channel (PUSCH); or physical random access channel (PRACH).

The term unified TCI (UTCI) may be interchangeably used with one or more of unified TCI-states, unified TCI instance, TCI, and TCI-state.

A time instance may represent a symbol, a slot, or a subframe.

The terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably to represent a measure of the quality of a reference signal.

The term sidelink may refer to a channel used for WTRU-to-WTRU communication.

The term bandwidth may be interchangeably used with bandwidth part (BWP), carrier, sub-band, and system bandwidth.

A type of slot may represent the slot direction, such as uplink, downlink, sidelink, or a combination thereof in case of full-duplex.

The term “sub-band” is used to refer to a frequency-domain resource and may be characterized by at least one of the following: a set of resource blocks (RBs), a set of resource block sets (RB sets), e.g. when a carrier has intra-cell guard bands, a set of interlaced resource blocks, a bandwidth part, or portion thereof, or a carrier, or portion thereof. For example, a sub-band may be characterized by a starting RB and number of RBs for a set of contiguous RBs within a bandwidth part. A sub-band may also be defined by the value of a frequency-domain resource allocation field and bandwidth part index.

A unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter.

The term “XDD” is used to refer to a sub-band-wise duplex (e.g., either UL or DL being used per sub-band) and may be characterized by at least one of the following: cross division duplex (e.g., sub-band-wise FDD within a TDD band); sub-band-based full-duplex (e.g., full-duplex as both UL and DL are used/mixed on a symbol/slot, but either UL or DL being used per sub-band on the symbol/slot); frequency-domain multiplexing (FDM) of DL/UL transmissions within a TDD spectrum; sub-band non-overlapping full-duplex (SBFD) (e.g., non-overlapped sub-band full-duplex); full-duplex other than a same-frequency (e.g., spectrum sharing, sub-band-wise-overlapped) full-duplex; or advanced duplex method, e.g., other than (pure) TDD or FDD.

The term transmission and reception point (TRP) may be interchangeably used with one or more of TP (transmission point), RP (reception point), RRH (radio remote head), DA (distributed antenna), BS (base station), gNB, a sector (of a BS), and a cell (e.g., a geographical cell area served by a BS). Hereafter, Multi-TRP may be interchangeably used with one or more of MTRP, M-TRP, and multiple TRPs.

A property of a grant or assignment may comprise at least one of the following:
a frequency allocation;
an aspect of time allocation, such as a duration;
a priority;
a modulation and coding scheme;
a transport block size;
a number of spatial layers;
a number of transport blocks;
a TCI state, CRI or SRI;
a number of repetitions;
whether the repetition scheme is Type A or Type B;
whether the grant is a configured grant type 1, type 2 or a dynamic grant;
whether the assignment is a dynamic assignment or a semi-persistent scheduling (configured) assignment;
a configured grant index or a semi-persistent assignment index;
a periodicity of a configured grant or assignment;
a channel access priority class (CAPC); or
any parameter provided in a DCI, by MAC or by RRC for the scheduling the grant or assignment.

Full Duplex Operation is discussed herein.

New Radio (NR) duplex operation may be a great foundation in improving conventional time division duplexing (TDD) operation by enhancing UL coverage, improving capacity, and reducing latency. The conventional TDD system is based on splitting the time domain between uplink and downlink. The feasibility of allowing full-duplex at the base station (e.g., gNB), within a conventional TDD band, may be a promising approach.

The NR system may be configured with one or more types of slots within a given bandwidth. The type of slot determines the direction of the transmission: uplink, downlink, or sidelink. In a frame with several slots, some slots may be configured to be of a first type (e.g., downlink, or sidelink) and other slots may be configured to be of a second type (e.g., uplink, or sidelink).

In a full-duplex system, a third type is introduced. This type of slot may be configured such that a first group of frequency resources within the bandwidth are allocated to transmission in the first direction and a second group of frequency resources within the bandwidth are allocated to transmissions in a second direction. A slot may also be flexible, and dynamically change UL/DL.

A full-duplex operation may be non-overlapping, partially overlapping, or fully overlapping. In the case of fully overlapping, a timeslot may be used for both uplink and downlink, using the same component carrier or band. In the case of non-overlapping, a slot may be configured for UL and DL at the same time, but the UL and DL transmissions occur in different sub-bands. A non-overlapping full-duplex system may be referred to sub-band non-overlapping full-duplex (SBFD) herein.

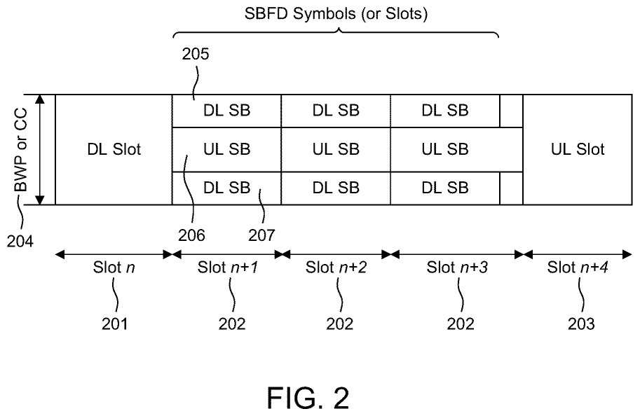

FIG. 2 illustrates a sub-band non-overlapping full-duplex (SBFD) system.

In the example in FIG. 2, a slot may be defined as either uplink, or downlink, or both. Slot n 201 is configured as a DL slot, slots n+1, n+2 and n+3 202 are configured as both UL and DL slots, and slot n+4 203 is configured as an UL slot. As shown in FIG. 2, a single band 204, represented here by a component carrier (CC) or bandwidth part (BWP), is split in three sub-bands 205, 206, 207, and two are configured to operate in the DL 205, 207, and one is configured to operate in the UL 206. Accordingly, the base station (e.g., gNB) may choose to use different sub-bands to different WTRUs, and WTRUs are not required to receive and transmit at the same time, thus reducing the complexity of WTRU physical layer design.

The term “dynamic(/flexible) TDD” may be used to refer to a TDD system where the communication in time instance (symbol, slot, subframe) may change dynamically. In one example, a component carrier(CC) or a bandwidth part (BWP) may be associated with one single type among ‘D’, ‘U’, and ‘F’ on a symbol/slot. The configuration may be provided to the WTRUs in an indication by a group-common(GC)-DCI (e.g., DCI format 2_0), comprising a slot format indicator (SFI), or in an RRC configuration information element, such as tdd-UL-DL-config-common/dedicated configurations. On a given time instance, a first base station (e.g., cell TRP, gNB) employing dynamic/flexible TDD may transmit a downlink signal to a first WTRU being associated with the first base station (e.g., gNB), using a slot that is configured for downlink transmission. A second base station (e.g., gNB), also employing dynamic/flexible TDD, may receive an uplink signal transmitted from a second WTRU in a slot that is configured for uplink transmissions. The first WTRU may determine that the reception of the downlink signal is being interfered by the uplink signal sent by the second WTRU. The interference caused by the second WTRU uplink transmission in the first WTRU downlink reception may be referred to as WTRU-to-WTRU cross-link interference (CLI).

Cross-link interference (CLI) is discussed herein.

The realization of a full-duplex system may be subject to resolving some of the key challenges raised due to cross-link interferences (CLI). In a full-duplex framework, a potential aggressor cell may switch from UL to DL, or vice-versa, causing CLI on potential victim base stations (e.g., gNBs) or WTRUs. In uplink (UL) to downlink (DL) CLI, the UL transmission from aggressor WTRUs may cause directional CLI at the victim WTRU. The CLI may be measured at both the victim and/or aggressor WTRUs.

In one example, a WTRU may receive configuration information or be configured with one or more full-duplex UL, DL, sidelink, flexible, and/or guard sub-bands in one or more DL/UL/flexible TDD time instances (e.g., symbols, slots, frames, and so forth). The WTRU may be configured with one or more resource allocations for full-duplex sub-bands.

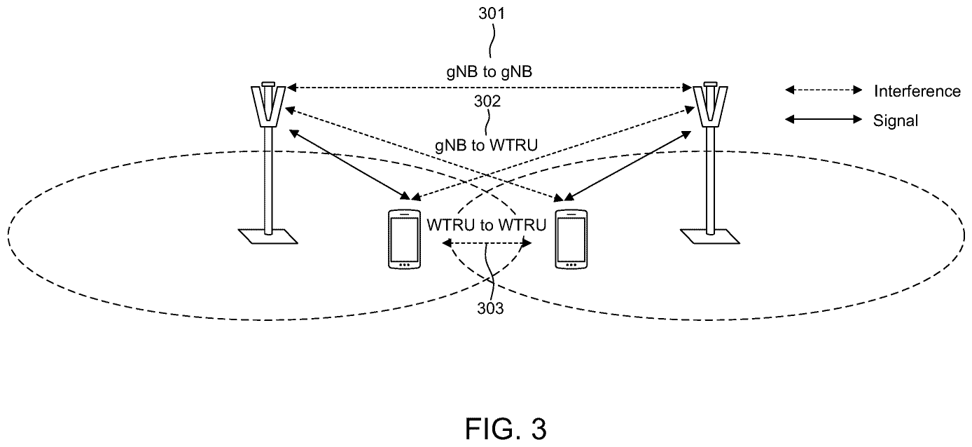

FIG. 3 illustrates cross-link interference (CLI) during full-duplex operation. The interference may be inter-gNB 301, between g-NB and a WTRU 302, or inter-WTRU 303.

In the evolution of NR specifications CLI measurement and reporting mechanisms have been primarily network-initiated. This paradigm is based on the system configuring a WTRU to perform layer-1 (physical layer) CLI measurements, then layer-1 may provide the measurements to layer-3 (radio resource control, RRC layer). RRC filtering may be performed, which may comprise, e.g., of a moving average. The RRC may then report the filtered measurement results to the network, e.g., using an RRC message. The RRC filtering time may be on the order of hundreds of milliseconds, e.g., between 100 ms to 300 ms. This may result in a high latency in terms of the network receiving the information. The asynchronous information flow may result in increased latency and added signaling burden on the network, as the network needs to wait and process updates from WTRUs. There is an interest in enabling WTRU initiated CLI reporting where the measurements may be performed, processed and reported directly from the physical layer. This results in measurements being available much faster, in the range of 3 ms to 10 ms.

WTRU determination of CLI is discussed herein.

In one example, a WTRU may determine the CLI via measuring pilot signals or reference signals from other WTRUs. An example of a pilot signal is a sounding reference signal (SRS). Other pilot signals may be used by WTRUs. SRS is used herein just as a non-limiting example of an RS.

When a first WTRU transmits an SRS, a second WTRU may measure the SRS signal strength received. This measurement may indicate the level of interference that the first WTRU may generate in the second WTRU reception. As an example, the second WTRU may measure the SRS reference signal received power (RSRP); a high value of RSRP measured may indicate that the second WTRU may generate high interference level when the first WTRU is receiving DL data from the base station (e.g., gNB).

In a system where WTRUs may use different antenna configurations, such as different antenna beams, the first WTRU may receive the signal from the second WTRU using a specific beam.

In one example, the first WTRU may use a beam that is used for DL reception from base station (e.g., gNB) to perform the measurement. By using the same beam that is used for DL reception, the first WTRU may estimate the interference the second WTRU may generate during downlink reception of the first WTRU.

In another example, the network may configure the first WTRU to use a specific beam when measuring the SRS of the second WTRU.

In another example, the second WTRU may be configured to send more than one reference signal and the first WTRU may be configured to measure one or more reference signals from the second WTRU.

In another example, the second WTRU may send the same SRS signal multiple times, using different beams at each time.

In another example, the first WTRU may use multiple beams to measure the SRS from the second WTRU, and determine which one is the highest (e.g., second-highest, third-highest, K-th highest, etc., which may be based on a configuration or indication form the network).

The first WTRU and the second WTRU may be configured by the network with such combination of SRS and antenna beams. The first WTRU may be configured with SRS to measure and receive (Rx) beam to be used when performing the measurement. The second WTRU may be configured with SRS to transmit and transmit (Tx) beam to be used in the transmission. In one simple example, the first WTRU may use the current DL beam to perform the measurements and the second WTRU may use the current UL beam to transmit the SRS. In general, the first WTRU may be configured with a set of {SRS, Rx beam} pairs to measure and the second WTRU may be configured with a set of pairs {SRS, Tx beam} to transmit. From the point of view of the first WTRU, it may only know the Rx beams, and not the Tx beams.

The first WTRU may not be limited to measuring SRS from a single (second) WTRU. There may be a plurality of WTRUs in the vicinity, in which case the first WTRU may be configured with a plurality of {SRS, Rx beam} pairs to measure. A CLI measurement may be associated to a pair {SRS, Rx beam}. In this context, an Rx beam is equivalent to DL beam and a beam is equivalent to a TCI-state.

Upon initially measuring the SRS-RSRP based on the candidate pairs, the first WTRU may determine a highest (or K-th highest) measured SRS-RSRP, measured using a first candidate pair {SRS-first, Rx-beam-first}, SRS-RSRP-first. The first WTRU may report this measurement to the network. Then first WTRU may continuously (or with high frequency) measure the candidate pairs and compare the measurement results with the last reported SRS-RSRP, SRS-RSRP-first.

In one example, the first WTRU may determine a first event is met on a condition that a measured SRS-RSRP of a second candidate pair {SRS-second, Rx-beam-second}, SRS-RSRP-second, is at least ‘Q’ (e.g., dB) higher than the last reported SRS, SRS-RSRP-first, e.g., SRS-RSRP-second>SRS-RSRP-first+Q. The first WTRU may request an UL resource to transmit the measurement report. The first WTRU may receive a grant for the UL resource. The first WTRU may report, via the UL resource, the measured SRS-RSRP-second of the second candidate pair, and may also add the candidate pair {SRS-second, Rx-beam-second} information in the report.

Events may also be defined based on a combination of measurements, such as a function of a plurality of SRSs measured using same or different Rx-beams. For example, it may be an average of all configured pairs. For example, it may be an average of measurements of a given SRS using a plurality of Rx-beams.

In one example, the WTRU may measure SRS-second using other RX beams and may report those results. In one example, the first WTRU may report those results in case any of the measurements exceed a certain threshold.

In one example, the first WTRU may be further configured to report measurements of a third candidate pair on a condition that the measured SRS-RSRP-third of the third candidate pair is at least ‘R’ higher than the last reported SRS-RSRP-first, e.g., SRS-RSRP-third>SRS-RSRP-first+Y, where Y<Q.

In one example, a WTRU may receive configuration associated with a first measurement set of DL beams (e.g., RSs, TCI states), a second measurement set of reference signals (e.g., SRSs, UL beam RSs), and at least one parameter for WTRU-initiated CLI measurement and reporting.

In one example, the WTRU may be configured with one or more SRSs to measure and the base station (e.g., gNB) may indicate which beam to use via a downlink control information (DCI). A beam may be indicated as a transmission configuration indicator (TCI) state, e.g., by a DCI. In one example, the beam may correspond to the indicated TCI-state (indicated by a TCI field in the DCI) when the WTRU is configured with the unified TCI framework.

In one example, the WTRU may not be pre-configured with any information, and the information {SRS, TCI-state}, may be indicated to the WTRU via a DCI or a MAC control element.

In one example, the WTRU may have the capability to autonomously discover the SRSs to measure.

The CLI measurement report may comprise information on a candidate beam paired with the candidate SRS, a quality metric of the current DL beam, the candidate DL beam and the corresponding candidate quality metric (L1-SINR) based on a pair of {the candidate DL beam, the candidate SRS}, one or more additional SRS(s) with corresponding quality that may satisfy an event condition, such as the ones described above.

Spatial domain filters and antenna beams are discussed herein.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an reference signal (RS), such as a channel state information RS (CSI-RS) or a synchronization signal block (SSB). The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

Quasi co-location (QCL) and transmission configuration indication (TCI) are discussed herein.

A WTRU may receive transmit configuration indication (TCI) related configuration(s), e.g., comprising a plurality of TCI-states (e.g., an RRC-configured pool of TCI-states (e.g., as unified TCI framework), ‘TCI-State’ IE, ‘TCI-UL-State’ IE, or ‘spatialRelationInfo’ IE). A TCI-state of the plurality of TCI-states may be associated (comprised) with at least one of QCL-info#1, QCL-info#2, additionalPCI, pathloss RS(PLRS)-ID, UL-PC, Timing Advance Group (TAG)-ID, where QCL-info#1 (or QCL-info#2) may comprise a cell-ID (e.g., serving-cell index), a BWP-ID, a RS (e.g., CSI-RS, SSB-index), and/or a QCL-type which may be one of typeA, typeB, typeC, typeD. TypeA may be associated with {Doppler shift, Doppler spread, average delay, delay spread}. TypeB may be associated with {Doppler shift, Doppler spread}. TypeC may be associated with {Doppler shift, average delay}. TypeD may be associated with {Spatial Rx parameter}.

In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop(CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command(TAC)(s)) in association with the TAG-ID (e.g., of multiple TAG-IDs being configured) to a scheduled UL transmission.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a CC. In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station, a gNB, a TRP, etc.) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/sub-bands, etc. A Unified TCI state instance may be equivalent or identified to a Coreset Pool identity (e.g., CORESETPoolIndex, a TRP indicator, and/or the like).

A WTRU may be configured with a plurality of transmission configuration indicator (TCI) states, e.g., unified TCI (UTCI) states. Each state may be applicable to one or more signals. The signals are configured in the WTRU by the RRC, and the configuration may comprise one or more of the following parameters: one or more CORESETs, one or more PDCCH candidates, one or more search spaces, one or more PDSCH occasions, one or more RSs (e.g., CSI-RSs, DMRSs, SSB indexes, PRSs, PTRSs, or SRSs), one or more PUSCH occasions, or one or more PUCCH resources, one or more PRACH occasions.

The plurality of TCI states may be configured via an RRC signaling (e.g., and/or via a MAC-CE signaling, indication or activation). The WTRU may receive, e.g., via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

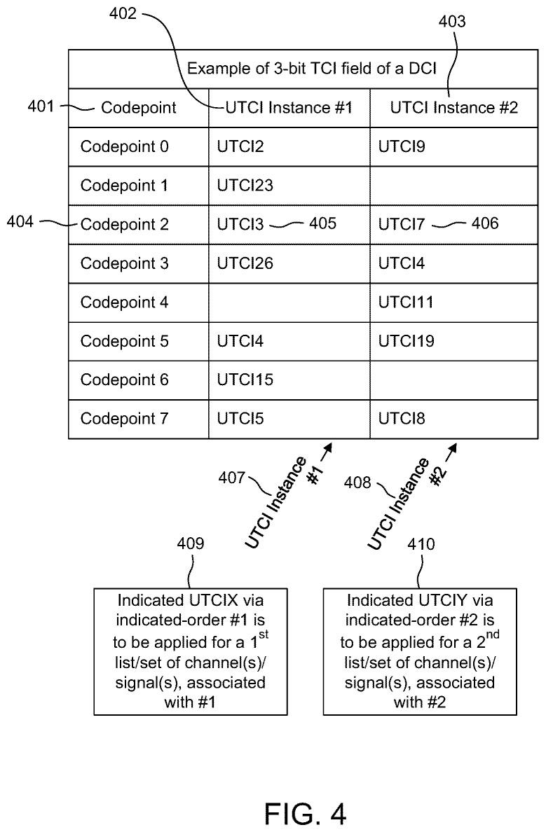

FIG. 4 shows an example of a DCI for unified TCI state indications.

In this example, a codepoint 401 is received in the TCI field located in the DCI and is mapped to a UTCI 402, 403. Specifically, in this example, the codepoint 401 comprises 3-bits to represent TCI states 0 to 7. This example is non-limiting, e.g., more or less TCI states may be defined. The WTRU may receive the mapping between the codepoint 401 and the UTCI 402, 403 in a field in the DCI. The WTRU may receive one or more TCI states, as illustrated in FIG. 4, via e.g., a MAC-CE signaling.

For example, codepoint 2 404 may be mapped to {UTCI 3 405, UTCI 7 406}, where the WTRU may apply at least one of UTCI 3 405, or UTCI 7 406 to a transmission of a specific signal. The UTCI to be used may be based on an association configured in the WTRU. For example, the base station (e.g., gNB) may configure, for each UTCI instance 407, 408, one or more signals that are associated with that UTCI instance. A UTCI instance may correspond to a column in the mapping table illustrated in FIG. 4: UTCI instance #1 407 and UTCI instance #2 408. As an example, if two sets of signals are configured, the first set may be associated with UTCI instance #1 409 and the second set may be associated with UTCI instance #2 410.

Channel state information (CSI) components are discussed herein.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

CLI measurements are discussed herein.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may be configured with one or more of: CSI report quantity (e.g., Channel Quality Indicator (CQI), Rank Indicator (RI), Precoding Matrix Indicator (PMI), CSI-RS Resource Indicator (CRI), Layer Indicator (LI)), CSI report type (e.g., aperiodic, semi-persistent, periodic), CSI report codebook configuration (e.g., Type I, Type II, Type II port selection), CSI report frequency, CSI-RS resource set, including NZP-CSI-RS resource for channel measurement, NZP-CSI-RS resource for interference measurement, or CSI-IM resource for interference measurement. NZP CSI-RS resources may include NZP CSI-RS resource ID, periodicity and offset, QCL info, TCI-state, resource mapping, e.g., number of ports, density, CDM type.

A WTRU may determine one or more RSs to measure. In one example, the RS(s) to measure may be configured in the WTRU by the base station (e.g., gNB), the configuration may be semi-static or dynamic. The configuration may be WTRU-specific, e.g., only for this WTRU, or it may be the same for more than one WTRUs or a group of WTRUs. In another example, the RS(s) to measure may be determined autonomously by the WTRU, using, for example, sensing mechanisms, matching filters, or measurements. In another example, the RSs to measure may be determined by the WTRU with assistance from the base station (e.g., gNB); in this case the base station (e.g., gNB) may provide some assistance information to the WTRU and the WTRU may use at least the assistance information received from the base station (e.g., gNB) to determine the RS(s) to measure. In another example, the WTRU may use the sidelink channel to communicate with one or more other WTRUs in vicinity and obtain information based on such communication. The information obtained may be control information sent from the one or more WTRUs. The information may be measurements/sensing performed by the WTRU in the sidelink channel. A combination of base station (e.g., gNB) assistance information and sidelink-associated information may be used by the WTRU to assist with the determination of the RS(s) to measure.

The beam, or TCI-state, to be used by each WTRU to transmit the reference signal may be configured, in a semi-static manner, or be indicated by the base station (e.g., gNB) before the transmission, in a dynamic fashion. For a UE transmitting more than one reference signals, the beam or TCI state may be the same for all transmissions or may be specific to the reference signal, e.g., each SRS may have a TCI-state associated to it.

The WTRU may monitor, receive, and measure one or more parameters based on the respective reference signals. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-Link interference received signal strength indicator (CLI-RSSI) may be measured based on the average of the total power contribution in configured OFDM symbols of the configured time and frequency resources. The power contribution may be received from different resources (e.g., cross-link interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

In the following, an indication by DCI may comprise an indication by a DCI field or by RNTI used to mask CRC of the PDCCH or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

The full-duplex configuration may include a flag signal (e.g., enabled/disabled). In one example, a first value (e.g., zero (0)) may indicate a first mode of operation (e.g., full-duplex configuration), and a second value (e.g., one (1)) may indicate a second mode of operation (e.g., non-full-duplex operation). The modes of operation (e.g., full-duplex and/or non-full-duplex) may be indicated via MIB, SIB, RRC, MAC-CE, or DCI.

The WTRU may receive the time resources (e.g., one or more symbols, slots, and so forth), for which the first mode of operation (e.g., full-duplex) is defined in for example one or more BWPs, sub-bands, component carriers (CC), cells, and so forth. The WTRU may receive the frequency resources (e.g., sub-bands/BWPs including one or more PRBs) within (active and/or linked) BWP, for which the first mode of operation (e.g., full-duplex) is configured. The time instances (e.g., slots, symbols) may be indicated based on periodic, semi-persistent, or aperiodic type configurations. In one example, the time instances may be indicated via a bitmap configuration, where each bit corresponds to a time instance (e.g., slot, symbol, subframe, etc.) and each bit indication indicates whether corresponding time instance can be used for the first or second mode of operation.

In one example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., full-duplex) is configured, one or more of the configured frequency resources (e.g., sub-bands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., full-duplex) is configured, one or more of the configured frequency resources (e.g., sub-bands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., full-duplex) is configured, one or more of the configured frequency resources (e.g., sub-bands, PRBs, and/or BWPs) may be configured for the first mode of operation (e.g., either UL transmission or DL reception based on the configurations).

The duplexing mode for the first mode of operation (e.g., full-duplex configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., full-duplex) may be configured as part of modes of operation configuration, for example via MIB, SIB, RRC, DCI, or MAC-CE.

The duplexing mode configuration and/or flag for the first mode of operation (e.g., full-duplex) may be configured as part of resource allocation configuration for a Tx/Rx occasion.

In one example, a WTRU may be configured with one or more types of slots. The WTRU may be configured with a first slot with a first type, where the first type may be for example full-duplex slot. The WTRU may be configured with a second slot with a second type, where the second type may be for example non-full-duplex slot. As for the first slot with the first type (full-duplex), the WTRU may be configured with one or more DL, UL, flexible, guard, sub-bands in the frequency domain, throughout the BWP, for the duration of the first slot. However, in the second slot with the second type (non-full-duplex), the WTRU may be configured with only one direction type, for example DL, UL, flexible, in the frequency domain, throughout the BWP, for the duration of the second slot.

In an example, if the WTRU is configured with a second slot with UL direction, it may imply legacy TDD UL slot, UL-only slot, and/or non-full-duplex UL slot. In another example, if the WTRU is configured with a third slot with second type (non-full-duplex) with DL direction, it may imply legacy TDD DL slot, DL-only slot, and/or non-full-duplex DL slot. In another example, if the WTRU is configured with a fourth slot with second type (non-full-duplex) with flexible direction, it may imply legacy TDD flexible slot and/or non-full-duplex flexible slot.

Full-duplex time-domain configuration is discussed herein.

A WTRU may receive configurations of (e.g., may be configured with) full-duplex sub-band time locations that may be configured within a period. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

When a (e.g., one, only one) TDD-UL-DL pattern is configured, full-duplex symbols may be configured in consecutive manner within a TDD-UL-DL pattern period. When two TDD-UL-DL patterns are configured and if full-duplex symbols are configured for only one of the patterns, full-duplex symbols may be configured in consecutive manner within the TDD-UL-DL pattern period. When two TDD-UL-DL patterns are configured and if full-duplex symbols are configured for both patterns, full-duplex symbols may be configured in consecutive manner within each TDD-UL-DL pattern period.

Physical Resource Blocks (PRBs) are discussed herein

A WTRU may determine (or be indicated/configured with) that ‘UL usable PRBs’ are a part of UL sub-band frequency resources within an UL BWP (e.g., an active UL BWP, a currently active UL BWP), and ‘DL usable PRBs’ are a part of DL sub-band frequency resources within an DL BWP (e.g., an active DL BWP, a currently active DL BWP). The UL usable PRBs may be determined as an intersection between a configured or indicated UL sub-band and an active UL BWP in full-duplex symbols (and/or slots). The DL usable PRBs may be determined as an intersection between a configured or indicated DL sub-band(s) and an active DL BWP in full-duplex symbols (and/or slots). In an (e.g., another) example, the UL and/or DL usable PRBs may be explicitly configured within active UL and/or DL BWP, e.g., in full-duplex symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a sub-band boundary, the WTRU may determine that (only) the PRBs within DL usable PRBs are to be valid for PDSCH reception and (only) the PRBs within UL usable PRBs are to be valid for PUSCH transmission, e.g., where this may imply “partial RBG” is allowed and valid for resource allocation.

QCL in a full-duplex system is discussed herein. More specifically the usage of separate QCL or TCI-state for full-duplex symbol type and non-full-duplex symbol type

In a full-duplex system, across full-duplex symbols and non-full-duplex symbols, it needs to be determined whether or not separate quasi co-location(QCL) and/or TCI-state configurations are applied, in consideration of different interference nature on different symbol types, e.g., due to non-negligible self-interference when using a DL beam on full-duplex symbols.

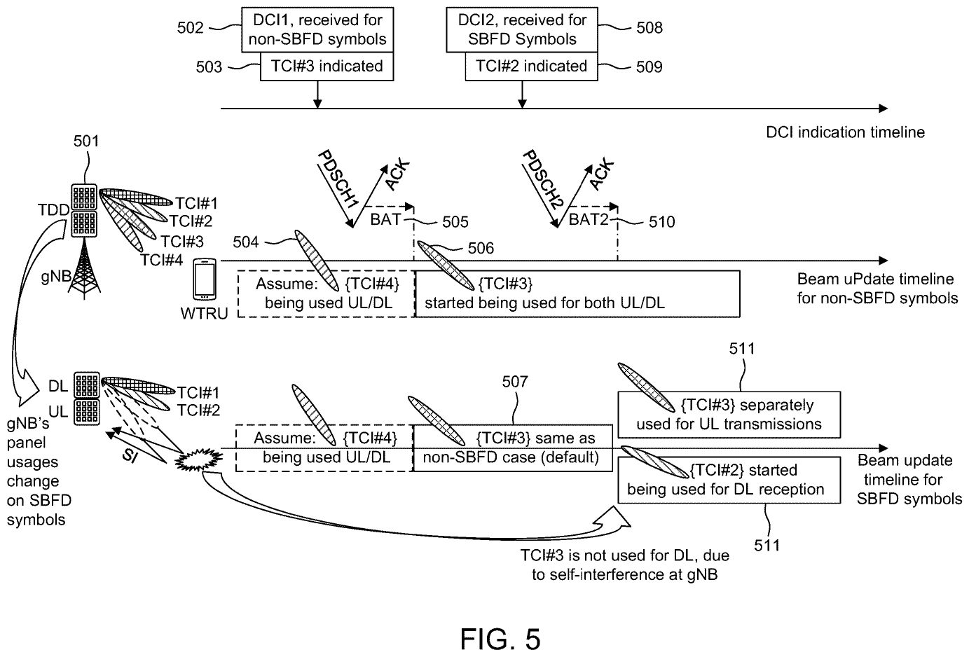

FIG. 5 illustrates an example of TCI or beam control across FD and non-FD symbols in a single TRP scenario and under unified TCI (UTCI) framework.

A WTRU may receive configuration of a plurality of TCI-states. The WTRU may receive a TCI-activation command (e.g., via a MAC-CE) indicating the one or more TCI-states to activate from the plurality of TCI states, such as shown in FIG. 5, for example, TCI#1, TCI#2, TCI#3, TCI#4 501. Upon receiving the activation command, the WTRU may monitor one or more quasi co-location (QCL) properties based on RSs within the activated set of TCI-states. The one or more QCL properties may comprise at least one of {average delay, Doppler shift, delay spread, Doppler spread, spatial Rx, and/or average power}. The activated set of TCI-states may be ready for being used for a transmission or a reception when scheduled.

The WTRU may receive a first DCI (DCI1) 502 scheduling a first PDSCH (PDSCH1) and indicating a first TCI-state, e.g., TCI#3 503, among the activated TCI-states. The WTRU may receive the first PDSCH using TCI#4 504, which is a previously indicated TCI-state, which in this case it is not the same as the indicated TCI#3. In response to receiving the first PDSCH using TCI#4 504, the WTRU may transmit an ACK to the base station (e.g., gNB) indicating a successful reception of the first PDSCH and/or a successful reception of the indicated first TCI-state, TCI#3 503.

The WTRU may start to use the indicated first TCI-state, TCI#3 503, after transmitting an ACK and after a time period, beam application time (BAT) 505. The value of a beam application time (BAT) 505, may be configured by the base station (e.g., gNB).

The WTRU may determine that the reception of DCI1 or the first TCI state (TCI#3) is associated with non-full-duplex symbols in terms of TCI/beam update 506. The determination may be based on an explicit indication from a base station (e.g., gNB) and/or based on an implicit rule, e.g., on condition of the symbol(s) where the DCI1 is received, which CORESET (and/or search space) the DCI1 is received, which RNTI the detected DCI1 is scrambled with. Based on determining that the reception of DCI1 or the first TCI state (TCI#3) is associated with non-full-duplex symbols, the WTRU may update the indicated first TCI state (TCI#3) for UL transmissions and/or DL receptions, e.g., at least for non-full-duplex symbols 506, or for both non-full-duplex symbols 506 and full-duplex symbols 507 until a full-duplex-specific TCI control command is received. In an example (e.g., by default), until (e.g., unless) a full-duplex-specific TCI control command is received, the WTRU may use the first TCI state (TCI#3) also in association with full-duplex symbols 507, e.g., for UL transmissions and/or DL receptions. In an example, the WTRU may transmit a first UL channel or signal (e.g., PUSCH, PUCCH, SRS) using the first TCI state (TCI#3), and/or receive a first DL channel or signal (e.g., PDSCH, PDCCH, CSI-RS) using the first TCI state (TCI#3).

The WTRU may receive a second indicated TCI-state in a second DCI 508, TCI#2 509. The WTRU may start to use the indicated second TCI-state, TCI#2 for at least one communication direction (e.g., DL), BAT2 510 after transmitting the ACK, where a BAT2 510 may be configured by the base station (e.g., gNB) and may be same as or independent from BAT 505.

The WTRU may determine that the reception of DCI2 or the second TCI state (TCI#2) is associated with full-duplex symbols in terms of TCI/beam update, where the reception of the DCI2 may correspond to the full-duplex-specific TCI control command. The determination may be based on an explicit indication from a base station (e.g., gNB) and/or based on an implicit rule, e.g., on condition of the symbol(s) where the DCI2 is received, which CORESET (and/or search space) the DCI2 is received on, or which RNTI the detected DCI2 is scrambled with. Based on determining that the reception of DCI2 or the second TCI state (TCI#2) is associated with full-duplex symbols, the WTRU may update the indicated second TCI state (TCI#2) for one communication direction (e.g., either UL transmission, or DL reception), where the one communication direction the WTRU applies for may be (pre-)configured or (separately) indicated by the base station (e.g., gNB).

In one example, based on determining that the reception of DCI2 or the second TCI state (TCI#2) is associated with full-duplex symbols, the WTRU may update the indicated second, TCI#2, for DL receptions 511, while the WTRU may continue to use the first TCI state, TCI#3, in association with full-duplex symbols for UL transmissions 512. In one example, the WTRU may continue to use the first TCI state, TCI#3, in association with non-full-duplex symbols, e.g., for UL transmissions or DL receptions.

In another example, not shown in FIG. 5, based on determining that the reception of TCI#2 is associated with full-duplex symbols, the WTRU may apply TCI#2 for UL transmissions or DL receptions which the WTRU performs on full-duplex symbol(s), while the WTRU may continue to use TCI#3 in association with non-full-duplex symbols for UL transmissions or DL receptions.

Based on receiving the full-duplex-specific TCI control commands indicating the TCI-state for full-duplex symbol(s) or non-full-duplex symbol(s), the reliability in one communication direction may be improved, while maintaining an optimized performance in the other communication direction. For example for the case where the base station (e.g., gNB) transmits a DL signal from a first base station (e.g., gNB) panel and simultaneously receives a UL signal at a second base station (e.g., gNB) panel, and some of DL beams (TCIs) (e.g., TCI#3, TCI#4) cause a self-interference on the UL reception, e.g., due to signal reflection, diffraction, by a clutter, obstacle, or by a non-ideal spatial-separation between the first and second base station (e.g., gNB) panels.

Configuration aspects related to full-duplex operation are discussed herein.

A WTRU may receive configurations for full-duplex (FD) operation conducted by at least one device in a network. In an example, the FD operation may be conducted by a base station (e.g., gNB) or another WTRU. The WTRU may operate in a half-duplex (HD) mode for communicating with the base station (e.g., gNB), where the HD mode may imply that, at any given time, the WTRU either performs an UL transmission or a DL reception, but does not perform UL and DL simultaneously. The WTRU may operate in an FD mode for communicating with the base station (e.g., gNB), if a corresponding WTRU capability is available and the WTRU may report the capability to the base station (e.g., gNB). The WTRU may receive a signal from the base station (e.g., gNB) indicating to the WTRU to use FD mode.

As previously discussed, the FD operation may imply at a given time a transmitter may simultaneously transmit a first signal and receive a second signal. The FD operation may comprise a sub-band overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a sub-band non-overlapping FD (SBFD) operation where a first frequency-domain resource allocated for the first signal (e.g., assigned within a configured sub-band, e.g., DL sub-band, usable DL PRBs).) does not have an overlap with a second frequency-domain resource allocated for the second signal (e.g., assigned within a configured sub-band, e.g., UL sub-band, usable UL PRBs).

A WTRU may receive full-duplex-related configuration including, e.g., frequency-domain location information of one or more sub-bands (e.g., DL sub-band, UL sub-band, flexible DL/UL sub-band, or guard-band) or time-domain location information of the one or more sub-bands. The time-domain location information may indicate a set of non-full-duplex symbols and a set of full-duplex symbols. A symbol within the set of non-full-duplex symbols may be a type of ‘DL symbol’, ‘UL symbol’ or ‘flexible symbol’. The WTRU may receive a DL signal on a symbol based on a type of ‘DL symbol’ in the set of non-full-duplex symbols. The WTRU may transmit a UL signal on a symbol based on a type of ‘UL symbol’ in the set of non-full-duplex symbols. The WTRU may either receive a DL signal or transmit a UL signal on symbol(s) based on a type of ‘flexible symbol’ in the set of non-full-duplex symbols, e.g., depending on one or more conditions with other signal(s) co-existing in the symbol(s).

WTRU-initiated reporting based on measured interference level of UL RS(s) from other WTRUs is discussed herein.

A WTRU may receive configuration of a measurement RS set, including one or more UL RS(s), e.g., SRS(s). CLI measurements may be performed when any type of full-duplex (FD) is configured, e.g., sub-band non-overlapping full-duplex (SBFD), sub-band overlapping full-duplex, spectrum-shared full-duplex (SSFD), or in-band full duplex (IBFD). CLI measurements may be performed when one or more system architecture and operation features, schemes, or modes may observe inter-WTRU interference.

In one example, a WTRU may determine an interference level of one or more UL RSs, such as an SRS of the measurement RS set. The interference level may be based on a configured metric, such as an RSRP, SRS-RSRP, Layer1-SRS-RSRP. For example, each measured interference level may be denoted (without loss of generality) as SRS-RSRP#1, SRS-RSRP#2, SRS-RSRP#3, . . . SRS-RSRP#N.

Note that the RS is measured by the WTRU, but it is sent by other WTRUs in the uplink. Thus, the RS is an UL RS measured by the WTRU using DL TCI-states.

In one example, a WTRU may determine an interference level of a combination of UL RSs, where the interference level may be derived by using a configured or indicated function (e.g., weighted averaging) and by measuring the combination of UL RSs. For example, each measured interference level may be denoted as SRS-RSRP#1 (for the first combination), SRS-RSRP#2 (for the second combination), SRS-RSRP#3 (for the third combination), . . . SRS-RSRP#N (for the N-th combination).

Measuring the combination of UL RSs may be performed in a periodic (or semi-persistent) measurement basis, based on corresponding measurement configuration and one or more measurement parameters, such as periodicity, time-domain offset, measurement starting or activation parameter, or semi-persistent measurements.

Measuring the combination of UL RSs may be performed in an aperiodic measurement basis, based on corresponding measurement configuration and one or more measurement parameters, such as parameters related to a triggering DCI and/or reporting channel/signaling, time-offset related parameters based on a time duration between the reception of the triggering DCI and the transmission of the measurement reporting.

The WTRU may sort or rank the measurement results based on a configured rule, such as from the highest SRS-RSRP value to the lowest SRS-RSRP value.

The WTRU may determine whether a measurement result is higher than a threshold.

The WTRU may determine whether a first event (Event-1) is satisfied, Event-1 may be pre-configured or indicated, activated, or configured. For example, Event-1 may be defined to check whether the highest measured SRS-RSRP value is greater than a threshold. In an example, if the highest measured SRS-RSRP value is higher than the threshold, the WTRU may determine that the condition for Event-1 is satisfied. In an example, the WTRU may receive some prioritization information associated with one or more SRS resource index(s) to be prioritized, or some SRS resource group(s) with higher priority for the measurement to be determined or configured.

The WTRU may determine a reference metric value (e.g., a reference SRS-RSRP value, a reference metric value as one of the configured/indicated metric such as an RSRP, SRS-RSRP, Layer1-SRS-RSRP, etc.) to be compared with one or more measured metric values, where a second event (Event-2) may be defined to conduct a comparison between a reference metric value and the one or more measured metric values with a second threshold(s). The WTRU may determine the reference metric value based on at least one of following:

The reference metric value may be configured or indicated, e.g., as an initial value of the reference metric value.

The reference metric value may be determined based on a rule, e.g., as the most-recent highest SRS-RSRP value reported to the network.

The reference metric value may be determined based on a rule, as the most-recent K-th highest SRS-RSRP value, where the value of K may be configured or determined by the WTRU implicitly, based on other conditions or parameters.

The WTRU may update the current reference metric value with a new reference metric value, based on a configured rule or a configured or indicated timeline (e.g., when a configured or indicated time offset/duration has elapsed after determining a new highest SRS-RSRP value, the WTRU may use this as the new reference metric value).

For example, Event-2 may be defined (e.g., configured, indicated) to check whether the highest (e.g., or K-th highest) measured SRS-RSRP value is greater than the second threshold value plus the (current) reference metric value. If the highest (or K-th highest) measured SRS-RSRP value is SRS-RSRP#3 and is higher than the second threshold plus a current reference metric value (e.g., a pre-identified SRS-RSRP value or an initial reference metric value), the WTRU may determine that Event-2 is triggered. In a next measurement instance, the WTRU may apply, based on the configured or indicated time offset/duration, SRS-RSRP#3 as a current reference metric value and compare with newly measured SRS-RSRP values, where this procedure may continue based on a configured or indicated rule or procedure.

In an example, the WTRU may receive a configuration or indication regarding a measurement periodicity (and/or evaluation periodicity) on deriving multiple metric values (e.g., the measured interference level, the one or more measured metric values, and/or the reference metric value, etc.), where the measurement periodicity may be set to a same periodicity. This may mean that the WTRU may perform the same number of measurement attempts for deriving each of the multiple metric values in a given measurement time window (e.g., duration, measurement cycle). This may provide benefits in terms of WTRU complexity reduction on deriving multiple metric values and/or increased robustness on the derivation based on a fair comparison among multiple metric values (e.g., for Event-2).

In an example, the WTRU may receive a configuration or indication of different measurement periodicities (and/or evaluation periodicities) on deriving multiple metric values (e.g., the measured interference level, the one or more measured metric values, and/or the reference metric value, etc.). This may mean that the WTRU may perform different numbers of measurement attempts for deriving each of the multiple metric values in a given (e.g., configured, indicated, determined) measurement time window (e.g., duration, measurement cycle).

The WTRU may determine that a particular metric value is to be derived with more measurement numbers, based on a configuration or rule.

The WTRU may determine that, even though the configured or indicated periodicity(es) of the UL RSs are different, an evaluation periodicity of one or more UL RSs may be set to the shortest periodicity of all the measurement UL RSs in a given measurement time window.

The determination made by the WTRU may be based on an internal function pre-configured in the WTRU, a specific configuration from the network, such as an RRC message, or an indication from the network, such as an indication in a MAC-CE or a DCI.

Determination of measurement quantities is discussed herein.

The WTRU may determine measurement quantities and other reporting contents based on the performed interference measurement (e.g., CLI measurement).

The measurement quantity(es) and/or other reporting content(s) may comprise at least one measurement metric value (e.g., SRS-RSRP) and its associated UL RS resource information, such as a resource index (e.g., SRS resource index). The measurement metric value (e.g., SRS-RSRP) may also be provided in the form of an index, by using a mapping table mapping index numbers to measurement results, such as dB values. The WTRU may select one entry of the table indicating the measurement metric value via a M-bit indication.

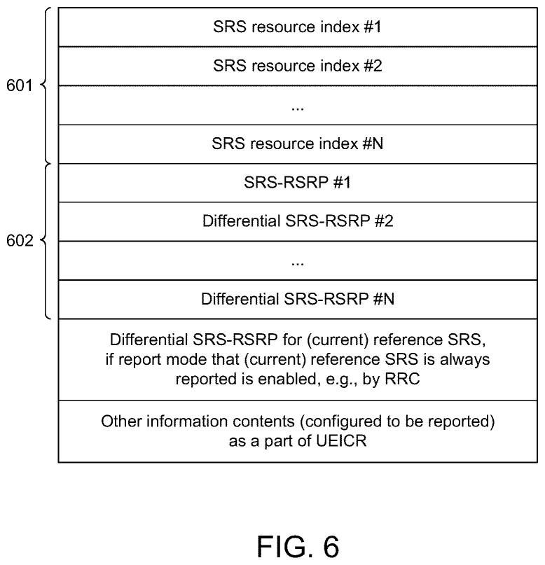

FIG. 6 illustrates an example of reporting CLI measurements for more than one SRS.

In the example in FIG. 6, a differential encoding is used. By using a differential encoding 602, lesser bits are needed to report the (e.g., less than M bits) per measurement metric value. For example, the WTRU may select one reference measurement value (e.g., SRS-RSRP value) to be reported by the M-bit indication. The other measurement quantities may be derived from a separate table for the differential encoding, using less than M bits. Each entry in the differential encoding table may indicate a different amount, e.g., different dB values, using less than M bits. The WTRU may report the reference value with M bits and the differential values for each SRS as the difference between the reference value and the SRS, using N bits for each SRS measurement result, where N<M.

The WTRU may (be configured to) perform a “cross-CC” measurement on deriving the at least one measurement metric value (e.g., SRS-RSRP) wherein a first metric value is derived from a first UL RS measured in a first component carrier (CC) (e.g., cell) and a second metric value is derived from a second UL RS measured in a second component carrier (CC) (e.g., cell).

CLI measurement reporting is discussed herein.

The WTRU may report the CLI measurement results, and other relevant information, in one or more instances.

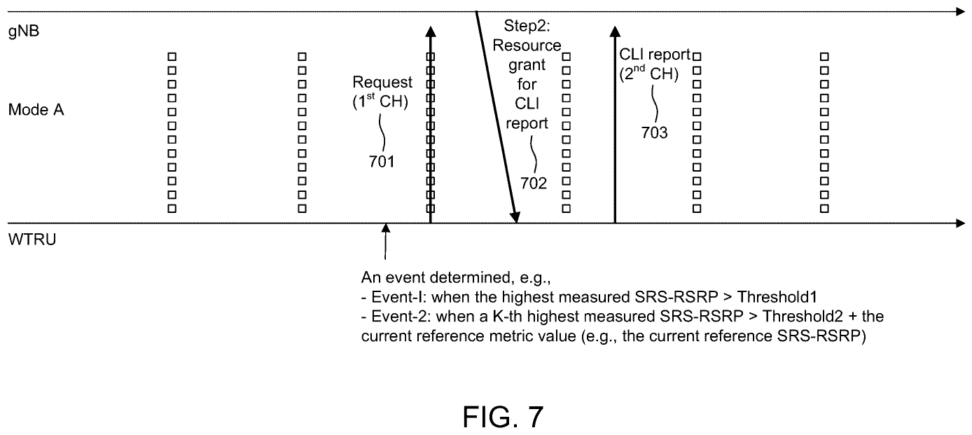

FIG. 7 illustrates an example of CLI measurement reporting using mode A.

In mode A, the WTRU may transmit a first UL signal 701, such as a short PUCCH resource carrying 1-bit or a small number of bits, to request resources to send the CLI report. The WTRU may receive a response, e.g., a DCI 702, which grants the resource. The DCI may be a UL grant scheduling a PUSCH transmission or a CLI request that may trigger the WTRU to send the CLI report via a uplink control information (UCI). Based on the response, the WTRU may send the CLI report 703 using the scheduled PUSCH, or using the UCI.

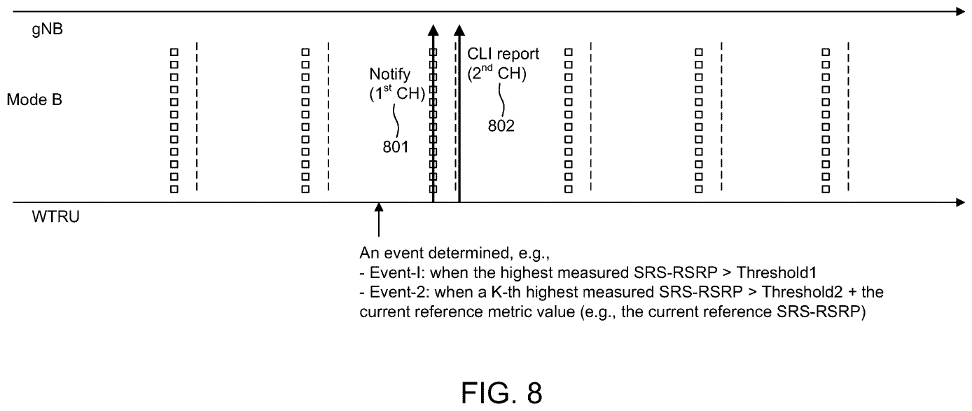

FIG. 8 illustrates an example of CLI measurement reporting using mode B.

In mode B, the WTRU may transmit a first UL signal 801, such as a short PUCCH resource carrying 1-bit or a small number of bits, to notify the network of an upcoming CLI report by using one of pre-configured UL resources (e.g., based on a Type-1 CG-PUSCH configuration). The WTRU may transmit the CLI report 802 via the pre-configured UL resource at the first available transmission occasion of the pre-configured UL resources. Optionally the WTRU may be configured to transmit the CLI report at the X-th transmission occasion of the pre-configured UL resources.

The WTRU may multiplex other UCIs (e.g., CSI feedback, beam reporting, etc.) or data bits (e.g., when there is data to be sent in the UL buffer) into the second channel. In one example, in case other UCIs are generated to be reported on an overlapped or partially-overlapped time or PRB, the WTRU may multiplex the information. The WTRU may apply a prioritization rule for the multiplexing. For example, if the payload size assigned for the second channel is not enough, the CLIU report may be the highest priority, followed by other UCI(s) (or a subset of the UCIs), followed by the data (or a subset of data), etc. Information payload with lower priority may be dropped during CLI report transmission.

Feedback from the base station (e.g., gNB) in response to the CLI report is discussed herein.

In response to a CLI report, the WTRU may receive one or more feedback messages from the network/base station (e.g., gNB). The feedback may be a confirmation of the successful reception of the CLI report. In one example, the confirmation message may be explicitly signaled via a DL signal. In another example, the confirmation message may be implicit; e.g., the reception of a request to update one or more CLI measurement related parameters may be an indication that the CLI report was received by the base station (e.g., gNB). In one example, the reception of a request to update one or more full-duplex related configuration parameters may be an indication that the CLI report was received by the base station (e.g., gNB). For example, DL or UL sub-band (or flexible sub-band where the direction of DL or UL is dynamically determined) related configuration may be updated (or re-configured, changed), size (e.g., number of RBs) of DL or UL or flexible sub-band may be updated, time-domain configuration on FD symbol(s) or non-FD symbol(s) may be updated, etc.

Parameters for retransmission attempts may be configured in the WTRU, e.g., when the WTRU does not receive a feedback. Parameters may indicate when to retransmit the CLI report, the number of times to retransmit, and other retransmission related parameters, such as counters (e.g., a prohibit timer), time-window (e.g., for allowed re-transmission time interval), etc.

The WTRU may further receive information on how to retransmit the CLI report, e.g., based on power ramping (e.g., increasing the Tx power level for the CLI report retransmission(s), based on spatial diversity (e.g., using different beam directions for retransmissions), whether to apply a repetition scheme or pattern for the retransmission (e.g., including the initial transmission of the CLI report).

In one example, he WTRU may retransmit a CLI report up to a number of times, e.g., up to Y times, where Y may be configured in the WTRU, unless the WTRU receives the confirmation from the base station (e.g., gNB) of the successful reception of the CLI report. The retransmission may be separately performed for the first UL channel and/or the second UL channel. In an example, the WTRU may perform retransmission of the first UL channel (e.g., request signal as in Mode-A, notifying signal as in Mode-B) unless a prohibit timer (e.g., if configured by the base station) is running. In an example, the WTRU may perform retransmission of the second UL channel delivering the CLI report unless a (second) prohibit timer (e.g., if configured by the base station) is running.

The WTRU may communicate with the base station (e.g., gNB) with two or more handshakes of messaging, e.g., until receiving an updated measurement RS set (e.g., MAC-CE based dynamic update of the measurement RS set). In one example, after the WTRU transmits CLI report (e.g., based on 3-step procedures in the mode A or 2-step procedures in the mode B), the WTRU may retransmit the CLI report, unless the WTRU receives a confirmation and/or receives the updated measurement RS set.

In one example, a WTRU may perform a WTRU-initiated CLI measurement and reporting procedure based on one or more configuration parameters. The WTRU may be configured with one or more candidate SRSs, wherein each candidate SRS has one or more receive TCI-states (or antenna beams) associated with it. The WTRU may perform measurements in the candidate SRSs using the associated TCI-state(s). The WTRU may report the highest CLI measurement. The WTRU may continue to monitor the candidate SRSs, by performing CLI measurements at certain periodicity, or aperiodically, or continuously. The WTRU may compare the CLI measurements of the SRS candidates with the last reported CLI measurement. Upon detecting a highest CLI measurement, highest by a given threshold, the WTRU may report new highest CLI and associated SRS, and the TCI-state, if applicable, to the network. The WTRU may have the capability to detect autonomously the candidate SRSs. The WTRU may autonomously select the TCI-state to use for each SRS measurement. The TCI-state may the DL TCI-state of the WTRU performing the measurements.

The WTRU may receive an initial SRS-ID to be compared with the candidate SRS measurements. The WTRU may receive an aperiodic CLI reporting trigger, where the WTRU may determine an SRS-ID with the highest CLI (e.g., strongest L1-SRS-RSRP) and transmit it (with the quality metric, e.g., SRS-RSRP). The network may indicate to the WTRU which SRS to use as baseline for comparison.

When a triggering event (e.g., Event-1, or Event-2) is met, the WTRU may report N (>=1) SRS measurements. The WTRU may use Mode-A, Mode-B, etc. The WTRU may receive an indication (e.g., via a RRC and/or MAC-CE) enabling or disabling whether the last reported SRS reported should be included in the CLI report. The network may use this information to make scheduling decisions for all WTRUs in a cell or in a set or group of cell or in a given geographical area.

WTRU-initiated CLI reporting based on measurements made on a combination of configured CLI resource(s) is discussed herein.

A WTRU may receive configuration(s) of a measurement RS set, including an RS set comprising one or more UL RSs, e.g., SRSs, or associated one or more DL beam configurations, where the WTRU is configured to perform a measurement (e.g., CLI measurement) based on the measurement RS set.

The WTRU may perform the measurement when in any type of full-duplex (FD) operation, e.g., sub-band non-overlapping full-duplex (SBFD), sub-band overlapping full-duplex or spectrum-shared full-duplex (SSFD), or in-band full-duplex (IBFD), etc.

The WTRU may perform the measurement when one or more features (or schemes or modes) considering inter-WTRU interference are enabled

The WTRU may determine an interference level (e.g., a configured/indicated metric such as an RSRP, SRS-RSRP, Layer1-SRS-RSRP) of one or more UL RSs such as an (e.g., each) SRS of the measurement RS set. In one example, the WTRU may use the same antenna beam/TCI-state for each RS measurement. In one example, the WTRU may use a different TCI state for each RS measurement, e.g., each RS may have an associated DL TCI state for measurement purposes. In one example, each RS may be measured with a plurality of TCI-states, where the plurality of TCI states may be the same for all RSs, or they may differ and be RS-specific. Each pair (RS, TCI state) may result in one measurement result, and the CLI measurement result may be a function of one or more measurement results. For example, each measured interference level may be denoted as SRS-RSRP#1, SRS-RSRP#2, SRS-RSRP#3, . . . SRS-RSRP#N and the CLI measurement may be reported for all N SRS-RSRP or as result of applying a function to the N SRS-RSRP values

The WTRU may determine a quality level (e.g., a configured/indicated metric such as a CLI-RSSI, RSSI, DL-beam-quality, L1-RSRP, L1-SINR) of a (e.g., each) DL (beam) RS (e.g., CSI-RS, SSB, etc.) of the measurement RS set. For example, each measured (DL) quality level may be denoted as DL-RSRP#1, DL-RSRP#2, DL-RSRP#3, . . . , DL-RSRP#N.

The WTRU may rank the multiple measurement results DL-RSRP#1, DL-RSRP#2, DL-RSRP#3, . . . DL-RSRP#N based on a configured or indicated rule, e.g., from the highest DL-RSRP value to the lowest DL-RSRP value. For example, the WTRU may determine the rank as DL-RSRP#3, DL-RSRP#1, DL-RSRP#2, . . . based on determining that DL-RSRP#3 is the highest DL-RSRP value of the derived multiple values, DL-RSRP#1 is the second-highest DL-RSRP value of the derived multiple values, and DL-RSRP#2 is the third-highest DL-RSRP value of the derived multiple values, and so on.

The WTRU may rank the multiple measurement results of DL-DL-RSRP#1, DL-RSRP#2, DL-RSRP#3, . . . DL-RSRP#N based on a configured or indicated rule, e.g., from the lowest DL-RSRP value to the lowest DL-RSRP value. For example, the WTRU may determine the rank as DL-RSRP#1, DL-RSRP#2, DL-RSRP#3, . . . based on determining that DL-RSRP#1 is the lowest DL-RSRP value of the derived multiple values, DL-RSRP#2 is the second-lowest DL-RSRP value of the derived multiple values, and DL-RSRP#3 is the third-lowest DL-RSRP value of the derived multiple values, and so on.

The WTRU may determine a worst SRS measurement (e.g., highest value measured, K-th highest value measured) that may be the last-reported SRS as a part of WTRU-initiated CLI measurement and reporting procedure. The WTRU may compare the last-reported SRS measurement (e.g., highest/K-th highest signal strength) with candidate SRSs using their associated DL beam. The WTRU may be configured with a pre-association between one or more DL beams and one or more SRSs. The given DL beam may correspond to the current indicated TCI-state, e.g., when the WTRU is configured with the unified TCI framework such as a joint DL/UL UTCI mode or a separate DL/UL UTCI mode.

The WTRU may determine an event is met based on a condition that a quality of a second SRS (that is associated with the given DL beam) is at least Q (e.g., dB) higher than the quality of the last-reported SRS. The WTRU may also measure the second SRS with different DL beams.

In one example, a performance metric (e.g., DL quality metric, CQI, CLI) may be derived based on a function of signal to interference and noise ratio (SINR) or signal to interference ratio (SIR). For example, a WTRU may measure the signal strength (RSRP, desired channel quality metric, desired channel power, for example) of a DL RS send by the base station (e.g., gNB) and measure signal strength (RSSI or RSRP, for example) of UL RS(s) sent by other WTRU(s), and/or measure any additional interference measurement (e.g., energy or power measurement on a configured CLI-RSSI resource and/or a configured DL-interference measurement resource such as CSI-interference-measurement(CSI-IM) resource, etc.). Then the ratio of the gNB DL RS measurement divided by one or more interference measurements (e.g., the measured CLI from the WTRU(s) UL RS(s) and/or the any additional interference measurement) may result in a SINR or SIR measurement (e.g., metric).

Determination of best DL TCI-state based on CLI is discussed herein.

A WTRU may perform a WTRU-initiated CLI measurement and reporting procedure, based on one or more configuration parameters, in order to aid the base station (e.g., gNB) in selecting a best DL beam/TCI-state for the WTRU to use. managing a sorted list of a pair of a DL beam (e.g., based on QCL type-D “spatial Rx” property) and a SRS-ID, (for a given DL beam) from the strongest L1-SRS-RSRP to the weakest L1-SRS-RSRP. The WTRU may determine a current pair of {DL beam, SRS beam}, where the DL beam may correspond to the current indicated TCI-state, and the SRS may correspond to the worst SRS (e.g., SRS with highest/K-th highest SRS-RSRP in the most recent measurement) beam in the CLI perspective of the WTRU. This procedure may be for joint checking with a serving DL beam (and its best/worst paired SRS beam, e.g., used in the SRS transmission from other WTRU).

In an example, for each measurement cycle of SRS(s) that may be transmitted from other WTRU, the WTRU may be configured to apply “a DL beam cycling (for measurement)”. The WTRU may be configured with a number of DL beams and a number of SRS-IDs. The WTRU may measure, on each measurement cycle, each configured SRS-ID using a plurality of different QCL type-D beam direction (TCI states). In one example, the WTRU may determine SINR based on the currently configured TCI state by measuring the DL RS sent by the base station (e.g., gNB) and measuring a given SRS. This will identify the current CLI caused by the given SRS.

In one example, the WTRU may determine SINR of a given SRS based on a plurality of TCI states. The WTRU may report the results to the network and the network may use this information to optimize the WTRU DL TCI state, and, if a change is needed, indicate a new DL TCI state to be used by the WTRU.

In one example, the WTRU may determine SINR considering all SRSs configured, where each measurement may be made using different TCI states. In this case the WTRU may determine SINR of a given TCI state N as a ratio between (gNB RS measurement using TCI state N) and (a function of all SRSs, e.g., measured using TCI state N). The WTRU may report the results to the network (e.g., base station, gNB), or may report the highest (or S-th highest) value to the network. Even though the highest value may not yield in the highest gNB RS measurement, the network may decide to indicate a new TCI state (e.g., the one that yields in the highest SINR) to the WTRU. The WTRU may report the results to the network and the network may use this information to optimize the WTRU DL TCI state, and, if a change is needed, indicate a new DL TCI state (e.g., as a new indicated TCI-state) to be used by the WTRU, using the plurality of TCI states.

In an example, one SRS-ID at a given period is to be checked for DL beams selection where the WTRU may report one or more (preferred) DL beams (e.g., each represented by a DL RS and/or a TCI-state) with higher DL quality metric (e.g., L1-RSRP, L1-SINR, etc.) based on assuming a CLI exists due to SRS transmission by other WTRU with the one SRS-ID. The WTRU may (be configured to) update the one or more DL beams to be used for one or more DL receptions (e.g., PDSCH, PDCCH), e.g., after sending the report and/or after receiving a confirmation from the BS.

In another example, one DL beam to be searched with a coupled of SRS beams, or some combination of both can be configured or indicated for the WTRU to conduct. The WTRU may have simultaneously CLI reporting procedures, e.g., one with a first DL-beam in an full-duplex symbol, to check a paired SRS beam quality, and another with a second DL-beam in a non-full-duplex symbol, to check a paired SRS beam quality.

In another example, although the WTRU may have the freedom to choose which DL beam to use for the CLI measurement, there may be a restriction, e.g., the WTRU may apply a candidate DL beam at least once (or X times) for event detection.

When the triggering event is met, the WTRU may report M (>=1) pairs of {SRS-ID, DL beam} in an CLI report instance. The WTRU may further receive an indication (e.g., via a RRC and/or MAC-CE) enabling or disabling whether the current pair of {SRS-ID, DL beam} with corresponding DL beam quality (e.g., L1-RSRP, L1-SINR, etc.) and/or SRS-RSRP is always reported in addition to the M pairs of {SRS-ID, DL beam}.

In another example solution, for such CLI measurement and reporting, instead of (or in addition to) having a separate procedure for such CLI report, the WTRU may (be configured to) perform WTRU-initiated (DL) beam (e.g., only reporting (preferred) DL beams, not considering SRS beams to be reported) based on incorporating CLI metric(s) (based on the SRS-RSRP values) in assessing whether the corresponding event for the WTRU-initiated DL beam reporting is met or not. For example, the WTRU may (be configured to) apply one or more bias parameters (e.g., prioritization for new (DL) beam selection, beam-specific CLI penalty for new (DL) beam selection, etc.) on one or more TCI states (Rx beams) which may be more impacted by CLI (determined by its paired SRS beam). In that case, the WTRU may (be configured to) not trigger an event to switch to this Rx beam because in consideration that the performance could be worse due to CLI (from the paired SRS beam) for that (DL) beam. In an example, the CLI may be determined by a configured (e.g., as paired) SRS ID or a “worst” SRS ID (or a best/K-th best SRS ID), etc.

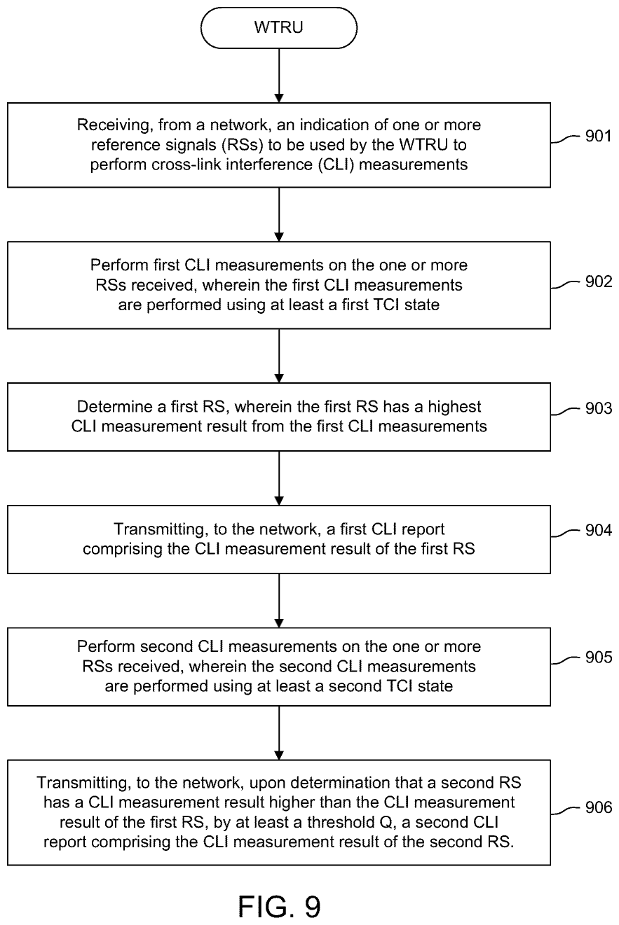

FIG. 9 illustrates an example of a CLI measurement and reporting procedure.

A WTRU may receive, from a network, an indication of one or more reference signals (RSs) to be used by the WTRU to perform cross-link interference (CLI) measurements 901. The one or more RSs may comprise one or more sounding reference signals (SRS) sent by one or more WTRUs in the vicinity.

The WTRU may perform first CLI measurements on the one or more RSs received, wherein the first CLI measurements are performed using at least a first TCI state 902. A CLI measurement result may comprise one of: a reference signal strength indicator (RSSI), a reference signal received power (RSRP), or a downlink RS signal to interference and noise ratio (SINR). In one example, the first TCI state may be the TCI state currently used by the WTRU to receive DL data from the network. In one example, a CLI measurement performed in one RS may comprise a set of measurements performed using a plurality of TCI states. In one example, the WTRU may apply a function to the RS measurements performed with different TCI states to obtain a CLI measurement result for that RS. In one example, the first CLI report may comprise a plurality of CLI measurements of the first RS made by the WTRU using a plurality of TCI states.

The WTRU may determine a first RS, wherein the first RS has a highest CLI measurement result from the first CLI measurements 903. The WTRU may transmit, to the network, a first CLI report comprising the CLI measurement result of the first RS 904.

The WTRU may perform second CLI measurements on the one or more RSs received, wherein the second CLI measurements are performed using at least a second TCI state 905. The first TCI state and the second TCI state may be indicated to the WTRU by the network. The first TCI state and the second TCI state may be identical. The WTRU may transmit, to the network, a second CLI report comprising the CLI measurement result of a second RS based on a comparison of the second RS CLI measurement result and the first RS CLI measurement result. The comparison may comprise a determination that the second RS has a CLI measurement result higher than the first RS CLI measurement result by at least a threshold, wherein the threshold is configured in the WTRU by the network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit and receive unit (WTRU), the method comprising:
receiving, from a network, an indication of one or more reference signals (RSs) to be used by the WTRU to perform cross-link interference (CLI) measurements;
performing first CLI measurements on the one or more RSs received, wherein the first CLI measurements are performed using at least a first TCI state;
determining a first RS, wherein the first RS has a highest CLI measurement result from the first CLI measurements;
transmitting, to the network, a first CLI report comprising the CLI measurement result of the first RS;
performing second CLI measurements on the one or more RSs received, wherein the second CLI measurements are performed using at least a second TCI state; and
transmitting, to the network, a second CLI report comprising the CLI measurement result of a second RS based on a comparison of the second RS CLI measurement result and the first RS CLI measurement result.

2. The method of claim 1, wherein the comparison comprises a determination that the second RS has a CLI measurement result higher than the first RS CLI measurement result by at least a threshold, wherein the threshold is configured in the WTRU by the network.

3. The method of claim 1, wherein the one or more RSs comprise one or more sounding reference signals (SRS).

4. The method of claim 1, wherein a CLI measurement result comprises one of: a reference signal strength indicator (RSSI), a reference signal received power (RSRP), or a downlink RS signal to interference and noise ratio (SINR).

5. The method of claim 1, wherein the first TCI state is a TCI state currently used by the WTRU to receive downlink data from the network.

6. The method of claim 1, wherein the first TCI state and the second TCI state are indicated to the WTRU by the network.

7. The method of claim 1, wherein the second CLI report further comprises a plurality of CLI measurements of the second RS made by the WTRU using a plurality of TCI states.

8. The method of claim 1, wherein the CLI measurement results for the first RS is determined based on CLI measurements performed in the first RS using a plurality of TCI states.

9. The method of claim 1, wherein the first CLI report comprises information on one or more TCI states used by the WTRU when measuring the first RS.

10. The method of claim 1, wherein the one or more RSs are received by the WTRU from other WTRUs.

11. A wireless transmit and receive unit (WTRU), the WTRU comprising at least one processor and a transceiver, wherein:
the at least one processor and the transceiver are configured to receive, from a network, an indication of one or more reference signals (RSs) to be used by the WTRU to perform cross-link interference (CLI) measurements;
the at least one processor and the transceiver are configured to perform first CLI measurements on the one or more RSs received, wherein the first CLI measurements are performed using at least a first TCI state;
the at least one processor and the transceiver are configured to determine a first RS, wherein the first RS has a highest CLI measurement result from the first CLI measurements;
the at least one processor and the transceiver are configured to transmit, to the network, a first CLI report comprising the CLI measurement result of the first RS;
the at least one processor and the transceiver are configured to perform second CLI measurements on the one or more RSs received, wherein the second CLI measurements are performed using at least a second TCI state; and
the at least one processor and the transceiver are configured to transmit, to the network, a second CLI report comprising the CLI measurement result of a second RS based on a comparison of the second RS CLI measurement result and the first RS CLI measurement result.

12. The WTRU of claim 11, wherein the comparison comprises a determination that the second RS has a CLI measurement result higher than the first RS CLI measurement result by at least a threshold, wherein the threshold is configured in the WTRU by the network.

13. The WTRU of claim 11, wherein the one or more RSs comprise sounding reference signals (SRS).

14. The WTRU of claim 11, wherein a CLI measurement result comprises one of: a reference signal strength indicator (RSSI), a reference signal received power (RSRP), or a signal to interference and noise ratio (SINR).

15. The WTRU of claim 11, wherein the first TCI state is a TCI state currently used by the WTRU to receive downlink data from the network.

16. The WTRU of claim 11, wherein the first TCI state and the second TCI state are indicated to the WTRU by the network.

17. The WTRU of claim 11, wherein the second CLI report further comprises a plurality of CLI measurements of the second RS made by the WTRU using a plurality of TCI states.

18. The WTRU of claim 11, wherein the CLI measurement results for the first RS are determined based on CLI measurements performed in the first RS using a plurality of TCI states.

19. The WTRU of claim 11, wherein the first CLI report comprises information on one or more TCI states used by the WTRU when measuring the first RS.

20. The WTRU of claim 11, wherein the one or more RSs are received by the WTRU from other WTRUs.
